(19) United States
(12) Patent Application Publication
(10) Pub. No.: US 2026/0186898 A1
(43) Pub. Date: Jul. 2, 2026

(54) DOMAIN-SPECIFIC LOW-COST DRAM SYSTEM

(71) Applicant: ScaleFlux, Inc., Milpitas, CA (US)

(72) Inventors: Yang Liu, Milpitas, CA (US); Fei Sun, Irvine, CA (US); Tong Zhang, Albany, NY (US)

(21) Appl. No.: 19/001,679

(22) Filed: Dec. 26, 2024

(51) Int. Cl. G06F 11/10

(52) U.S. Cl. CPC G06F 11/1044; G06F 11/1064

(57) ABSTRACT

A memory controller for a (dynamic random-access memory) DRAM die having m DRAM banks. The memory controller includes: an ECC engine configured to provide error correction for the plurality of DRAM banks, wherein the ECC engine includes: an encoding system configured to provide error correction coding (ECC) coding redundancy to a data component and generate an ECC codeword; and a partitioning system configured to partition the ECC code word into m segments for storage in the m DRAM banks, wherein a first subset of the m segments each include a portion of the data segment and a portion of the ECC coding redundancy, and a second subset of the m segments each include only ECC coding redundancy.

### TECHNICAL FIELD

The present invention relates to the field of solid-state memory, and particularly to reducing the cost of DRAM (dynamic random-access memory) devices.

### BACKGROUND

Modern computers use DRAM (dynamic random-access memory) chips to implement memory systems. One DRAM device consists of multiple DRAM banks that can operate concurrently and independently from each other. The minimum access granularity of one DRAM bank typically ranges from 4B to 32B (i.e., when a processor accesses one DRAM bank, it will at least read/write 4B˜32B of data). For application domains that demand very high memory access bandwidth (e.g., AI and high-performance computing (HPC)), they tend to deploy special types of high-bandwidth DRAM devices such as HBM (high-bandwidth memory) DRAM, (Low Power Double Data Rate) LPDDR DRAM, and (Graphics Double Data Rate) GDDR DRAM. In such high-bandwidth DRAM devices, each DRAM bank tends to have relatively coarse minimum access granularity (e.g., 16B and 32B). Modern host processors (e.g., central processing unit (CPU) and graphics processing unit (GPU)) have a large amount of on-chip cache memory and hence their minimum DRAM access granularity is their cache line size that typically ranges from 32B to 64B. Meanwhile, as the DRAM manufacturing technology continues to scale down, DRAM devices are subject to more and more soft and hard failures and hence demand the use of strong memory fault tolerance. Memory fault tolerance heavily relies on error correction code (ECC).

To best support host processors (e.g., CPU/GPU) to randomly read/write a cache line to/from DRAM, one ECC codeword should protect only one or two cache lines. For example, given cache line size of 32B, one ECC codeword protects 32B or 64B data (i.e., one or two cache lines). For high-bandwidth DRAM devices, each bank has relatively coarse minimum access granularity (e.g., 16B and 32B). As a result, one ECC codeword protects data from only a small number of banks. For example, if one ECC codeword protects 64B data and one bank has an access granularity of 32B, one ECC codeword protects data from only two banks. Due to the inevitable manufacturing process variation, different DRAM banks tend to exhibit different raw reliability. By only protecting data from one or two banks, the ECC puts strict constraints on allowable worst-case bank raw reliability, which further leads to strict constraints on DRAM manufacturing technology scalability. This will result in higher DRAM cost.

### SUMMARY

Accordingly, embodiments of the present disclosure are directed to systems and methods that can reduce DRAM cost for throughput-demanding application domains such as artificial intelligence (AI) and HPC.

A first aspect includes a memory controller for a (dynamic random-access memory) DRAM die having a m DRAM banks, the memory controller comprising: an ECC engine configured to provide error correction for the plurality of DRAM banks, wherein the ECC engine includes: an encoding system configured to provide error correction coding (ECC) coding redundancy to a data component and generate an ECC codeword; and a partitioning system configured to partition the ECC code word into m segments for storage in the m DRAM banks, wherein a first subset of the m segments each include a portion of the data segment and a portion of the ECC coding redundancy, and a second subset of the m segments each include only ECC coding redundancy.

A second aspect includes a memory controller for a dynamic random-access memory (DRAM) die having m DRAM banks, the memory controller comprising: an error correction code (ECC) engine configured to provide error correction for the plurality of DRAM banks, wherein the ECC engine includes: an encoding system configured to provide ECC coding redundancy to a data component and generate an ECC codeword; and a partitioning system configured to partition the ECC code word into m segments for storage in the m DRAM banks, wherein a first subset of the m segments each include a portion of the data segment, and a second subset of the m segments each include only ECC coding redundancy; and a plurality of error detection code (EDC) encoders, wherein each EDC encoder adds d error detection bits to each of the m segments.

### BRIEF DESCRIPTION OF THE DRAWINGS

The numerous advantages of the present invention may be better understood by those skilled in the art by reference to the accompanying figures in which:

FIG. 1 illustrates a multi-bank structure of a DRAM die.

FIG. 2 illustrates the use of per-bank on-die ECC in modern DRAM chips.

FIG. 3 illustrates the use of large-size ECC in memory controller in accordance with an embodiment.

FIG. 4 illustrates the construction of a large-size DRAM ECC codeword and the storage into multiple DRAM banks in accordance with an embodiment.

FIG. 5 illustrates complementing the large-size DRAM ECC with per-bank error detection coding in accordance with an embodiment.

FIG. 6 illustrates the operational flow diagram of serving a fine-grained read request after complementing the large-size DRAM ECC with per-bank error detection coding, where all the banks store ECC coding redundancy in accordance with an embodiment.

FIG. 7 illustrates the rotated mapping between super-codewords and DRAM banks to improve DRAM read speed performance in accordance with an embodiment.

FIG. 8 illustrates complementing the large-size DRAM ECC with per-bank error detection coding, where only m-k banks store ECC coding redundancy in accordance with an embodiment.

FIG. 9 illustrates the operational flow diagram of serving a fine-grained read request, where only m-k banks store ECC coding redundancy in accordance with an embodiment.

FIG. 10 illustrates the operational flow diagram of serving a fine-grained write request, where only m-k banks store ECC coding redundancy in accordance with an embodiment.

FIG. 11 illustrates the structure of one cache block in the proposed cache that is integrated into the memory controller to further reduce DRAM write amplification in accordance with an embodiment.

FIG. 12 illustrates the operational flow diagram of evicting a cache block from the cache that is integrated into the memory controller to further reduce DRAM write amplification in accordance with an embodiment.

### DETAILED DESCRIPTION

Reference will now be made in detail to the presently preferred embodiments of the invention, examples of which are illustrated in the accompanying drawings.

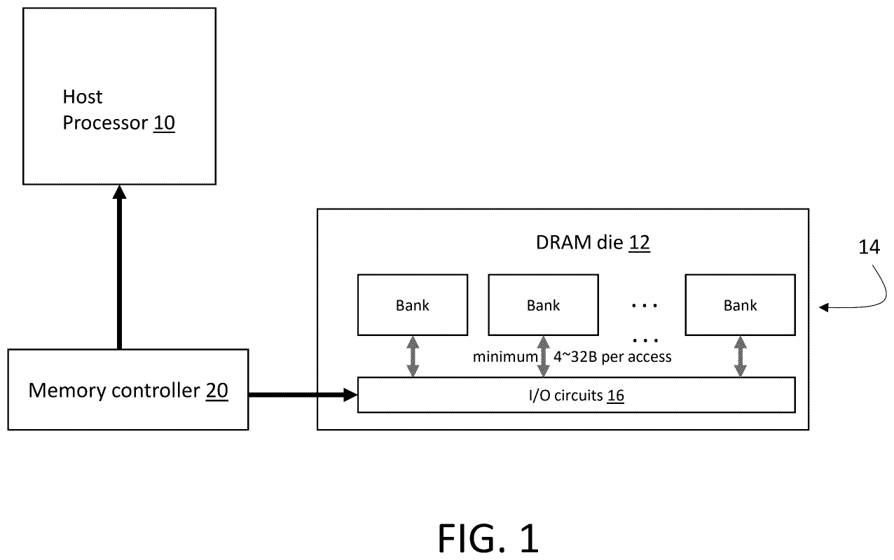

FIG. 1 illustrates a DRAM die 12 that consists of multiple DRAM banks 14 that can operate concurrently and independently from each other. A “DRAM die” generally refers to the individual semiconductor chip that contains the circuitry for DRAM, essentially the core component of a RAM chip where data is stored and accessed by a computer processor. It can be a single, small piece of silicon that holds all the necessary components to function as a DRAM unit, including the memory cells that store data as electrical charges on capacitors. All the DRAM banks share the I/O circuits 16 that is responsible for communicating with an external memory controller 20, which may be a standalone device, integrated into host processor 10 (also referred to herein as a “host”) or integrated into the DRAM die 12. The minimum access granularity of one DRAM bank 14 typically ranges from 4B to 32B (i.e., when accessing one DRAM bank, the memory controller 20 should at least read/write 4B˜32B of data). For special types of high-bandwidth DRAM devices such as HBM (high-bandwidth memory) DRAM, LPDDR DRAM, and GDDR DRAM, they tend to have relatively coarse bank minimum access granularity (e.g., 16B and 32B).

ECC (error correction code) is widely used to mitigate the DRAM operational errors. For an ECC codeword that protects k-bit data with r-bit coding redundancy, its redundancy ratio is defined as r/k. Given the same ECC redundancy ratio (hence the same ECC-induced DRAM storage cost overhead), the ECC error correction strength improves as we increase the ECC codeword length.

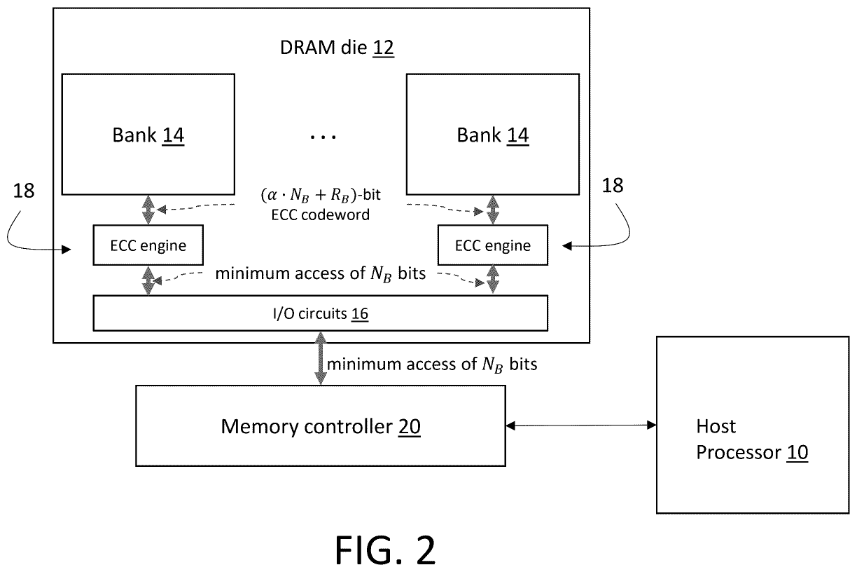

As shown in FIG. 2, to enhance the data storage integrity, modern DRAM chips integrate on-die ECC to realize memory error correction inside each DRAM die 12. Since different banks operate independently, DRAM chips implement on-die ECC independently for different DRAM banks, i.e., one ECC codeword protects data from only one DRAM bank. Hence, as illustrated in FIG. 2, each DRAM bank 14 has its own ECC engine 18. Let N_{B} denote the bank minimum access granularity and suppose one ECC codeword protects (α·N_{B})-bit data using R_{B}-bit coding redundancy. When memory controller 20 accesses N_{B}-bit data from one DRAM bank 14, the associated ECC engine performs the ECC encoding/decoding, and accordingly reads/writes an (α·N_{B}+R_{B})-bit codeword from/to the DRAM bank 14. The ECC-induced memory read/write amplification is α, i.e., to read/write the N_{B}-bit data, ECC engine must read/write α×more data from/to the DRAM bank 14. Read/write amplification on each DRAM bank 14 directly degrades how well the DRAM chip can serve host read/write requests (i.e., degrades the speed performance of DRAM chips). Therefore, modern DRAM chips typically keep the value of a very small, e.g., only 1 or 2. This leads to a short ECC codeword length, hence relatively weak DRAM error correction strength.

Due to the inevitable manufacturing process variations, different DRAM banks may exhibit significantly different raw reliability. In modern DRAM chips, one ECC codeword only protects data from one bank 14, hence the ECC must be able to adequately accommodate the worst-case DRAM bank raw reliability. This creates a strict constraint on the allowable worst-case DRAM bank raw reliability, which further limits the DRAM manufacturing scalability.

Systems and methods described herein can significantly lessen the constraint on the allowable worst-case DRAM bank raw reliability, which can contribute to greatly facilitating the DRAM manufacturing scalability and hence improving the DRAM cost effectiveness. In particular aspects, the described embodiments focus on DRAM devices being deployed in computing systems that mainly serve applications with dominantly coarse-grained (i.e., large) memory access patterns. Representative applications include, e.g., artificial intelligence (AI) and HPC (high-performance computing). For example, when running most AI workloads on a GPU, even though a GPU cache line size is only 32B, AI workloads tend to access memory in much bigger granularity such as 512B and larger. Leveraging such coarse-grained memory access patterns, current embodiments accordingly increase the DRAM ECC codeword length so that each ECC codeword protects data from multiple (e.g., 8) DRAM banks. This will largely lessen the constraint on the allowable worst-case DRAM bank raw reliability due to the averaging effect, which can greatly facilitate the DRAM manufacturing scalability and hence improve DRAM cost effectiveness.

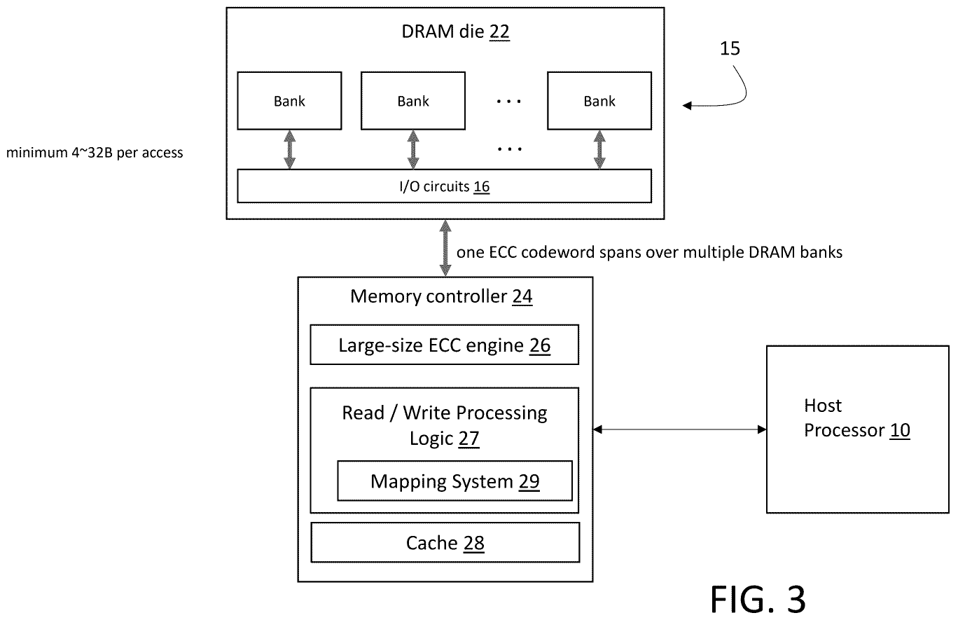

As shown in FIG. 3, rather than implementing a small on-die ECC engine 18 for each DRAM bank individually, the present embodiments implement a large-size ECC engine 26 for the m DRAM banks 15 in DRAM die 22 (where m is an integer). In this illustrative embodiment, the large-size ECC engine 26 is implemented in a separate memory controller 24, which also includes read/write processing logic 27 and in some aspects cache 28. While shown separately from the DRAM die 22 and host processor 10, it is understood that memory controller 24 can be integrated with host processor 10 and/or DRAM dies 22.

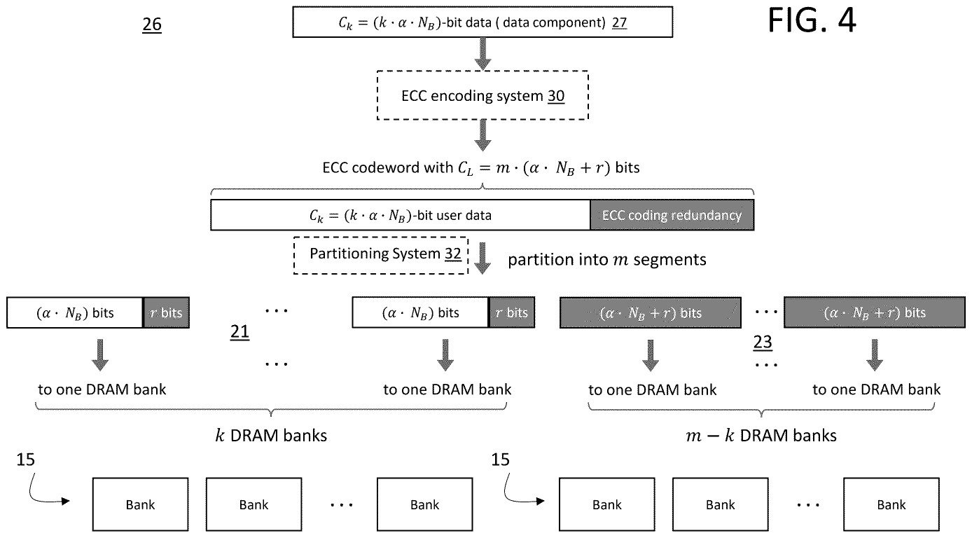

FIG. 4 illustrates an example construction and read/write processing logic 27 for large-size ECC engine 26 for DRAM die 22 (FIG. 3), which includes an ECC encoding system 30 and a partitioning system 32. Recall that N_{B} represents the bank minimum access granularity. The present logic 27 sets each large-size DRAM ECC codeword to consist of a total C_{L}=m·(α·N_{B}+r) bits, where each (α·N_{B}+r)-bit segment is stored in one distinct DRAM bank 14. Each ECC codeword protects a total Cₖ=(k·α·N_{B})-bit data (i.e., data component or user data 27), where k≤m and each group of (α·N_{B})-bit data is stored in one distinct DRAM bank 14. Hence, there are total (C_{L}−Cₖ)-bit ECC coding redundancy. As illustrated in FIG. 4, for each group of Cₖ=(k·α·N_{B})-bit data, the system applies ECC encoding to generate (C_{L}−Cₖ)-bit ECC coding redundancy, where C_{L}=m·(α·N_{B}+r). For each ECC codeword, the system stores (α·N_{B})-bit data and r-bit ECC coding redundancy in one bank for k DRAM banks, and stores (α·N_{B}+r)-bit ECC coding redundancy each in one bank for the remaining m−k DRAM banks.

Accordingly, in this embodiment, partitioning system 32 partitions the ECC code word into m segments for storage in the m DRAM banks 15, wherein a first subset 21 of the m segments each include a portion (α·N_{B}) of the data component 27 and a portion (i.e., r bits) of the ECC coding redundancy, and a second subset 23 of the m segments each include only ECC coding redundancy (α·N_{B}+r).

Note that this approach is particularly useful for DRAM devices being deployed in computing systems that mainly serve applications with dominantly coarse-grained memory access patterns. Once the ECC codeword length becomes significantly larger than the host processor cache line size (e.g., 512B ECC codeword length versus 32B cache line size), it will result in large DRAM read/write amplification under random cache line memory access. For example, suppose one ECC codeword is 512B and host processor cache line size is 32B. When host processor 10 randomly accesses different cache lines of DRAM, the system must read/write one 512B ECC codeword in DRAM to serve one 32B cache line access request, leading to a read/write amplification of 512B/32B=16. A larger read/write amplification inside DRAM chips results in a significant DRAM speed performance degradation from the host processor's perspective. Therefore, this approach focuses on DRAM devices being deployed in computing systems that mainly serve applications with dominantly coarse-grained memory access patterns. This is because coarse-grained memory access patterns help to reduce the DRAM read/write amplification in the presence of large DRAM ECC codeword length. However, even for such application domains, increasing the DRAM ECC codeword length in some cases can potentially cause noticeable performance degradation for two reasons:
1. As modern processors (CPU/GPU) integrate more and more computing resources, they may host many diverse applications. As a result, applications that have dominantly coarse-grained memory access patterns may co-exist with other applications that have notable amount of random fine-grained memory accesses. As a result, a certain percentage of DRAM accesses may be subject to large DRAM read/write amplifications, leading to noticeable or even significant degradation of the overall DRAM speed performance.
2. Even if all the applications running on the processor have dominantly coarse-grained memory access patterns, the processor may interleave the memory access requests from different applications so that DRAM chips experience fine-grained memory access patterns. This could cause noticeable DRAM read/write amplification and hence hurt the overall DRAM speed performance, even though all the applications have predominantly coarse-grained memory access patterns.

To mitigate the above problems, a set of techniques are provided that share the objective of reducing the DRAM read/write amplification in the presence of random fine-grained memory access when using large-size DRAM ECC.

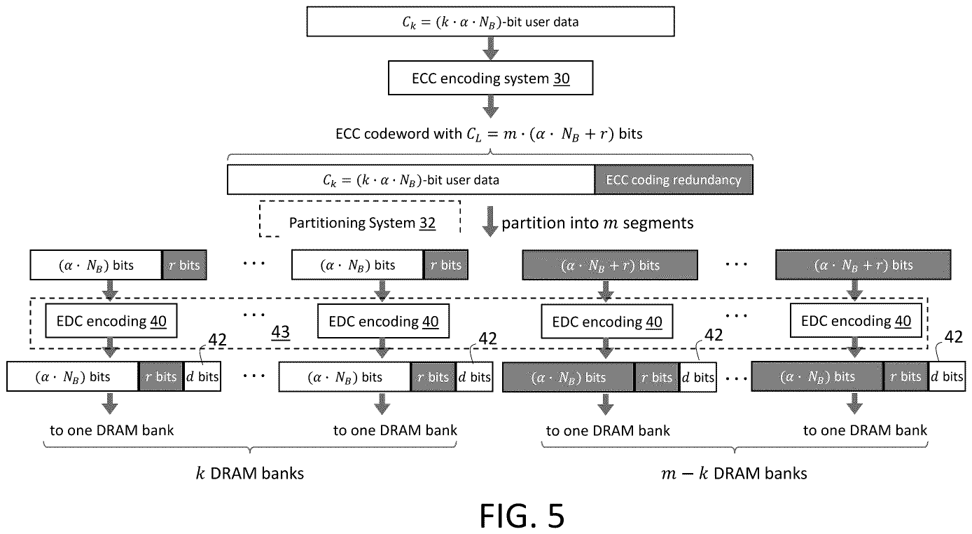

The following technique complements the large-size DRAM ECC with a fine-grained EDC (error detection code) implemented by a set of EDC encoders 43, shown in FIG. 5. Recall that Ng represents the DRAM bank minimum access granularity. In the original construction of large-size DRAM ECC as illustrated in FIG. 4, with the total codeword length of C_{L}=m·(α·N_{B}+r), each DRAM ECC codeword protects a Cₖ=(k·α·N_{B})-bit data component 27 with (C_{L}−Cₖ)-bit ECC coding redundancy. Each DRAM bank stores α·N_{B}+r bits. The basic idea of this technique is to apply EDC encoding 40 to generate d-bit EDC coding redundancy for each group of (α·N_{B}+r) bits being stored on each DRAM bank 15. Hence, associated with one large-size ECC codeword, each DRAM bank stores an (α·N_{B}+r+d)-bit EDC codeword consisting of (α·N_{B}+r)-bit data and d-bit EDC coding redundancy (collectively a super-codeword). Accordingly, this embodiment further comprises a plurality of EDC encoders, wherein each EDC encoder adds d error detection bits to each of the m segments.

If the host processor 10 only needs to read the N_{B}-bit data from one DRAM bank, to reduce the DRAM read/write amplification, the read/write processing logic 27 always first reads the (α·N_{B}+r+d)-bit EDC codeword from the DRAM bank and performs the error detection. Then, only if errors are indeed detected, the logic 27 reads the entire large-size DRAM ECC codeword from all the m DRAM banks and performs ECC decoding to reconstruct the requested data.

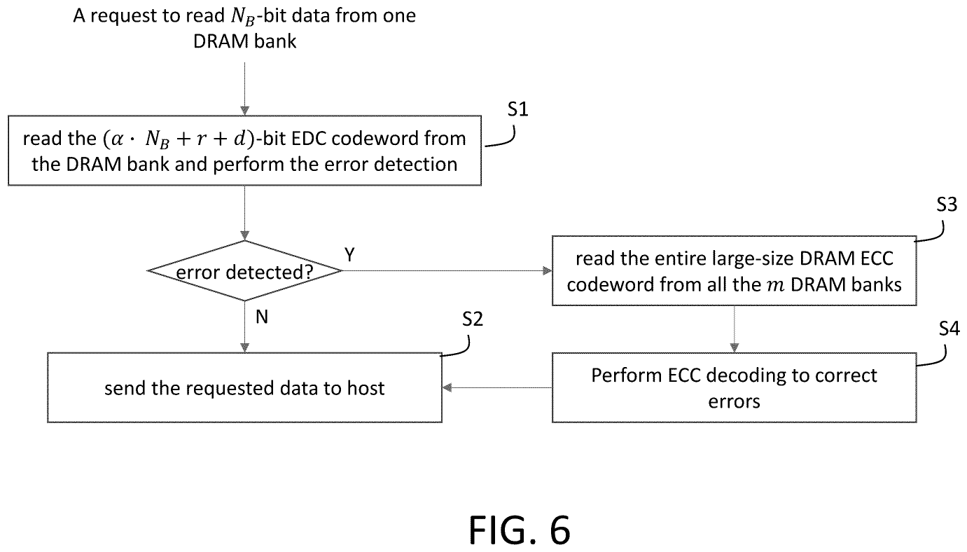

The read processing logic is illustrated in FIG. 6. When a read request is received to read N_{B}-bit data from one DRAM bank, the (α·N_{B}+r+d)-bit EDC codeword is read from the DRAM bank and error detection is performed at S1. If no errors are detected, the requested data is sent to the host of S2. If an error is detected, then the entire large-size DRAM ECC codeword from all the m DRAM banks at S3, and EEC decoding is performed at S4 to correct the errors. The resulting data is then sent to the host at S2. Since the DRAM raw error rate tends to be low, the probability of invoking the large-size DRAM ECC decoding tends to low (e.g., <10⁻⁵). Hence, this approach can (almost) completely eliminate the DRAM read/write amplification in the case of random fine-grained memory access.

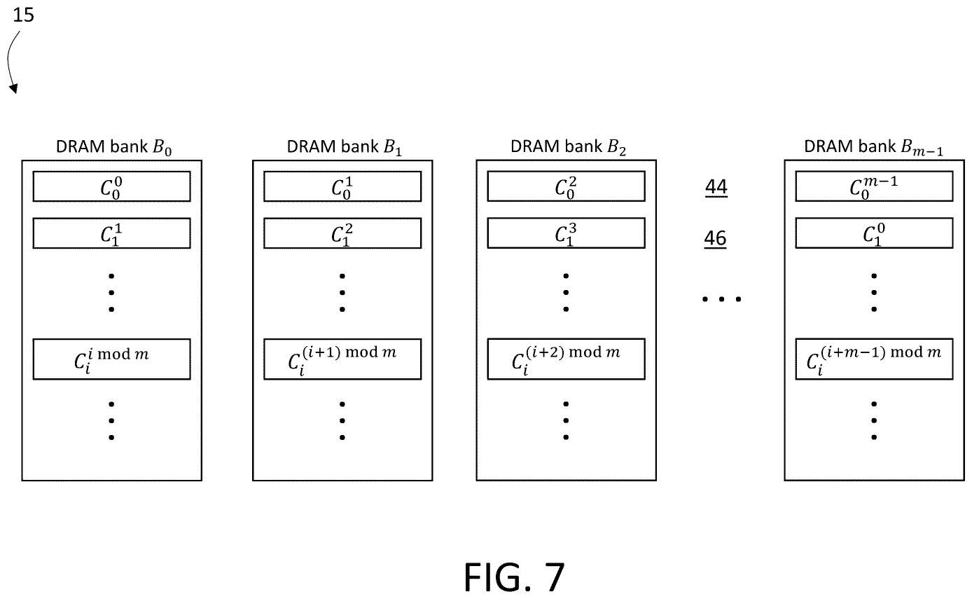

To further improve the effectiveness of the above design technique, a customized data placement among the banks 15 (i.e., implemented by mapping system 29 (FIG. 3)) may be implemented as shown in FIG. 7. Namely, mapping system 29 rotates placement of ECC codeword among the m DRAM banks. For example, one ECC codeword and its associated EDC coding redundancy together form a super-codeword. Suppose one group of m DRAM banks can store total L super-codewords, denoted as C₀, C₁, . . . , C_{L-1}. Meanwhile, denote the m DRAM banks as B₀, B₁, . . . , Bₘ₋₁. The i-th super-codeword Cᵢ is expressed as

$$[ {C}_{i}^{0} , {C}_{i}^{1} , … , {C}_{i}^{m - 1} ] ,$$

where each segment

$${C}_{i}^{j}$$

contains (α·N_{B}+r+d) bits that are stored together on one DRAM bank. The first k

$${C}_{i}^{j} ’ s ( i . e . , {C}_{i}^{0} , {C}_{i}^{1} , … , {C}_{i}^{m - 1} )$$

contain all the Cₖ=(k·α·N_{B})-bit user data and the remaining

$$m - k {C}_{i}^{j} ’ s ( i . e . , {C}_{i}^{k + 1} , {C}_{i}^{k + 2} , … , {C}_{i}^{m} )$$

contain only coding redundancy. For the i-th super-codeword Cᵢ, the DRAM bank Bₜ stores its segment

$${C}_{i}^{j} ,$$

where j=(i+t)mod m. As illustrated in FIG. 7, rotated mappings of super-codewords in the DRAM banks is achieved. For example, the first super-codeword 40 begins in the first bank B₀, the second super-codeword 42 begins in the last bank Bₘ₋₁, etc. The purpose of such rotated mapping between super-codewords and DRAM banks is to ensure that all the DRAM banks experience similar access intensity under a large number of random fine-grained read access. This can help to improve the overall DRAM read speed performance.

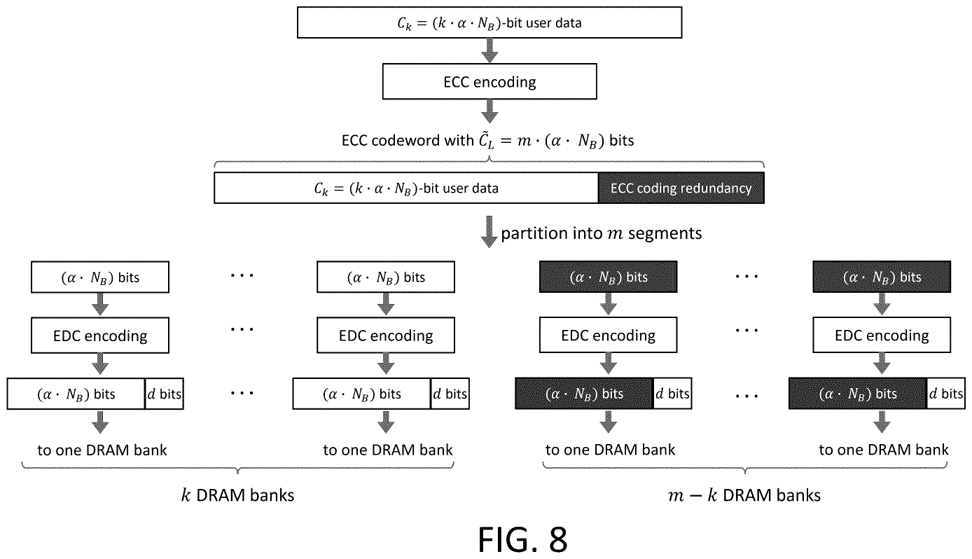

To further reduce the DRAM write amplification in the presence of random fine-grained write requests, a further enhancement to the above presented design approach can be implemented as shown in FIG. 8. In the above design, each DRAM bank stores (a. N_{B}+r+d) bits for one super-codeword. To further reduce the DRAM write amplification in the presence of random fine-grained write requests, the value of r is reduced to zero. Given Cₖ=(k·α·N_{B})-bit user data, the system applies ECC encoding to produce a \tilde{C}₁=(m·α·N_{B})-bit ECC codeword with the (\tilde{C}_{L}−Cₖ)-bit ECC coding redundancy. Then it applies EDC encoding on each (α·N_{B})-bit user data being stored on each DRAM to generate d-bit EDC coding redundancy. Hence, each DRAM bank stores an (α·N_{B}+d)-bit segment, and only m−k DRAM banks store ECC coding redundancy.

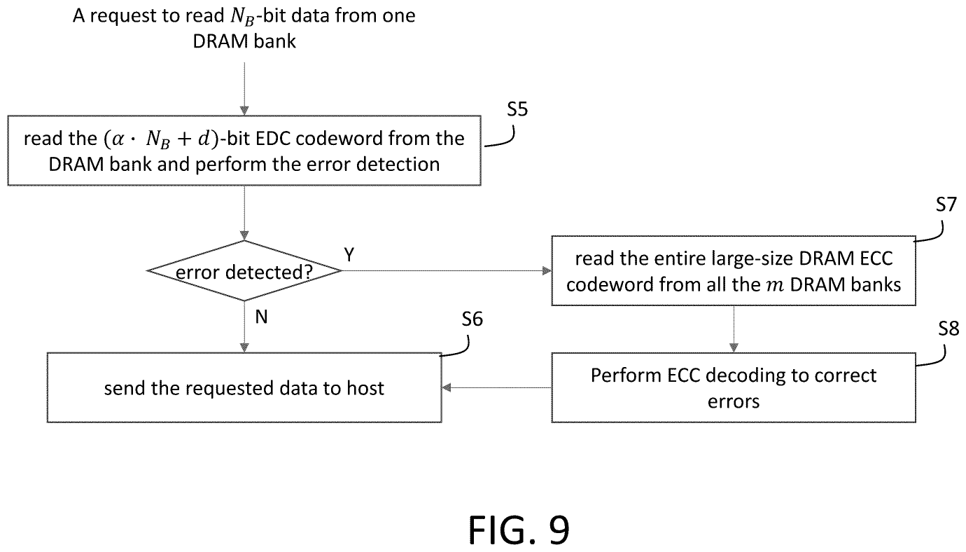

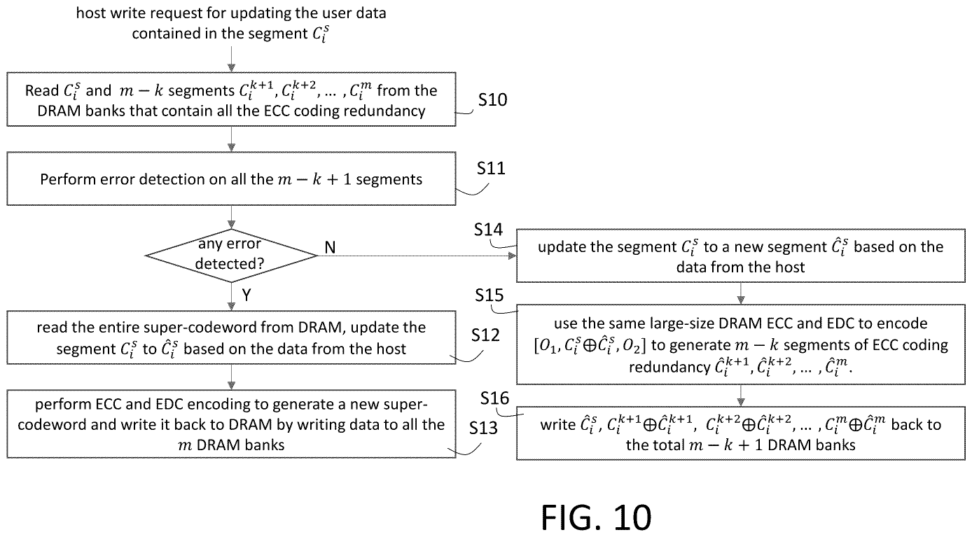

The read/write processing logic 27 of serving random fine-grained DRAM access is shown in FIG. 9.
As illustrated in FIG. 9, if the host processor 10 only needs to read the N_{B}-bit data from one DRAM bank, to reduce the DRAM read, first read the (α·N_{B}+d)-bit EDC codeword from the DRAM bank and perform the error detection at S5. If no errors are detected, send the requested data to the host. If errors are indeed detected, then read the entire large-size DRAM ECC codeword from all the m DRAM banks at S7 and performance ECC decoding to reconstruct the requested data at S8.
To reduce the DRAM write amplification in the presence of random fine-grained write requests, the system can use the read/write processing logic as illustrated in FIG. 10: Let

$${C}_{i} = [ {C}_{i}^{0} , {C}_{i}^{1} , … , {C}_{i}^{m - 1} ]$$

denote one super-codeword, where each

$$( α \cdot {N}_{B} + d ) - bit {C}_{i}^{j}$$

segment is stored in one DRAM bank. The first k segments

$${C}_{i}^{0} , {C}_{i}^{1} , … , {C}_{i}^{k - 1}$$

contain all the Cₖ=(k·α·N_{B})-bit user data and all ECC coding redundancy are stored in the remaining

$$m - k {C}_{i}^{j} ’ s ( i . e . , {C}_{i}^{k + 1} , {C}_{i}^{k + 2} , … , {C}_{i}^{m} ) .$$

If the host needs to update the user data contained in the segment

$${C}_{i}^{s} ,$$

first the system only reads

$${C}_{i}^{s} and the m - k segments {C}_{i}^{k + 1} , {C}_{i}^{k + 2} , … , {C}_{i}^{m}$$

from the DRAM banks that contain all the ECC coding redundancy at S10. Subsequently, it performs error detection on each segment at S11:
If none of the segments contain errors, it updates the segment

$${C}_{i}^{s}$$

to a new segment

$${\hat{C}}_{i}^{s}$$

based on the data from the host at S14, and then uses the same large-size DRAM ECC and EDC to encode

$$[ {O}_{1} , {C}_{i}^{s} ⊕ {\hat{C}}_{i}^{s} , {O}_{2} ]$$

(where O₁ is an (s−1)·(α·N_{B})-bit all-zero vector and O₂ is an (k−s)·(α·N_{B})-bit all-zero vector) to generate m-k segments of ECC coding redundancy

$${\hat{C}}_{i}^{k + 1} , {\hat{C}}_{i}^{k + 2} , … , {\hat{C}}_{i}^{m}$$

at S15. Then it writes

$${\hat{C}}_{i}^{s} , {C}_{i}^{k + 1} ⊕ {\hat{C}}_{i}^{k + 1} ,$$

$${C}_{i}^{k + 2} ⊕ {\hat{C}}_{i}^{k + 2} , … , {C}_{i}^{m} ⊕ {\hat{C}}_{i}^{m}$$

back to the total m−k+1 DRAM banks at S16.
If any one EDC detection detects errors, then it reads the entire super-codeword from DRAM, update the segment

$${C}_{i}^{s}$$

to a new segment

$${\hat{C}}_{i}^{s}$$

based on the data from the host at S12, and performs ECC and EDC encoding to generate a new super-codeword and write it back to DRAM by writing data to all the m DRAM banks at S13.

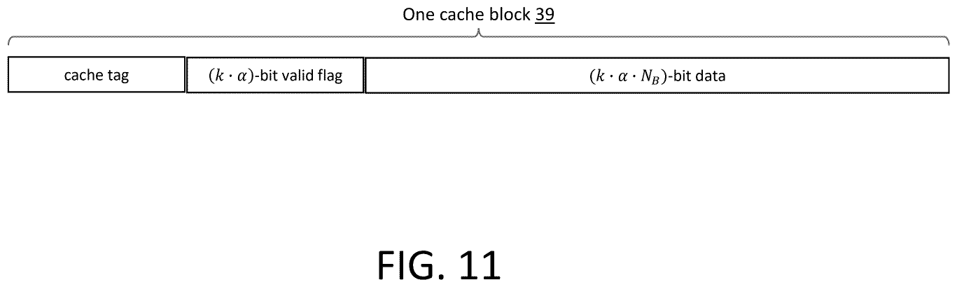

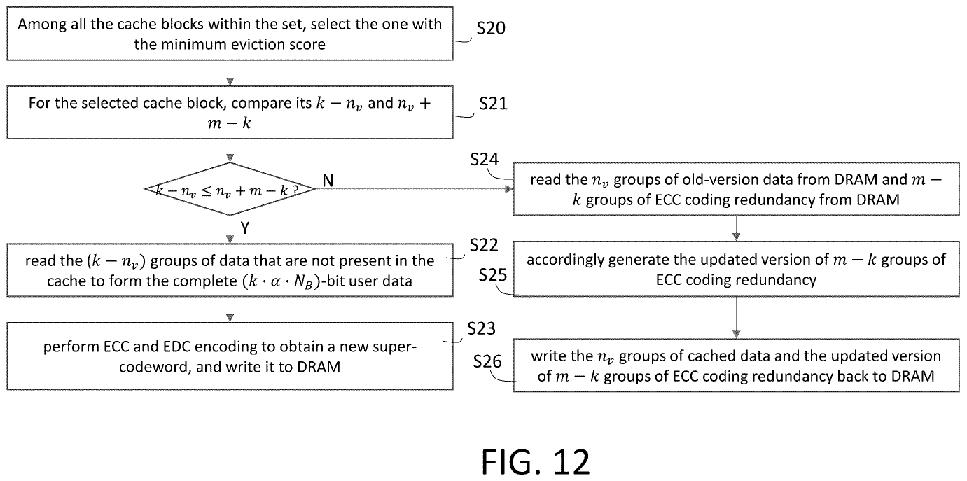

A further technique that can further reduce the DRAM write amplification may also be implemented with reference to FIGS. 3, 11 and 12. In this case, a cache 28 is integrated into the memory controller 24. Recall that each large-size DRAM ECC codeword contains (k·α·N_{B})-bit data (i.e., a data component). The cache 28 is configured only hold user data being written by the host 10 and is partitioned into nₛ sets, each set contains n_{b} blocks, and each block can store (k·α·N_{B})-bit data. The cache uses the classical set-associative cache architecture, i.e., data at any memory address is mapped to exactly one set, but within the set, it can be placed in any available block. Nevertheless, its management is completely different from classical set-associative cache: Within each (k·α·N_{B})-bit cache block 39, the cache 28 keeps 1-bit valid flag for each N_{B}-bit user data. After evicting the data in one cache block to DRAM, all the associated valid flag bits are reset to 0. Therefore, as illustrated in FIG. 11, within each cache entry, besides the cache tag as in classical cache and (k·α·N_{B})-bit cache block, the controller adds a (k·a)-bit valid flag. After the cache block 39 receives one Np-bit data segment, the corresponding valid flag bit will be set to 1. When one cache set becomes full and needs to evict one cache block to DRAM, the system performs cache block eviction as illustrated in FIG. 12. For one (k·α·N_{B})-bit cache block, the system puts its (k·a)-bit valid flag into k-groups, each group contains α-bit valid flags associated with (α·N_{B})-bit user data being stored in one DRAM bank. Let nᵥ denote the number of groups in which all the α-bit valid flags are 1. Accordingly, we define its eviction score as sₑ=min(k−nᵥ, nᵥ+m−k). Among all the np blocks within the set, it chooses and evicts the block with the minimum eviction score to DRAM at S20. During cache block eviction, memory controller 24 will perform different operations dependent on the relationship between k−nᵥ and nᵥ+m−k determined at S21.
If k−nᵥ≤nᵥ+m−k so that the eviction score sₑ=k−nᵥ, then it performs the ECC codeword re-encoding operation: read the (k−nᵥ) groups of data that are not present in the cache to form the complete (k·α·N_{B})-bit user data at S22, perform ECC and EDC encoding to obtain a new super-codeword, and write the new super-codeword to DRAM (S23).
If k−nᵥ>nᵥ+m−k so that the eviction score sₑ=nᵥ+m−k, then it performs partial data update: first read the nᵥ groups of old-version data from DRAM and m−k groups of ECC coding redundancy from DRAM at S24, and then accordingly generates the updated version of m−k groups of ECC coding redundancy at S25, and finally write the nᵥ groups of cached data and the updated version of m−k groups of ECC coding redundancy back to DRAM at S26.

It is understood that aspects of the present disclosure may be implemented in any manner, e.g., hardware, computer chips, as a software/firmware program, an integrated circuit board, a controller card, etc., that includes a processing core, I/O, memory and processing logic. Aspects may be implemented in a combination of hardware and software. Aspects of the processing logic may be implemented using field programmable gate arrays (FPGAs), application specific integrated circuit (ASIC) devices, and/or other hardware-oriented systems.

Aspects also may be implemented with a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, etc. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on a host computer, partly on a host computer, on a remote computing device (e.g., a memory card) or entirely on the remote computing device. In the latter scenario, the remote computing device may be connected to the host computer through any type of interface or network. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to control electronic circuitry in order to perform aspects of the present disclosure.

Computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by hardware and/or computer readable program instructions.

The flowcharts and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the present disclosure has been presented for purposes of illustration and description. It is not intended to be exhaustive or to limit the concepts disclosed herein to the precise form disclosed, and obviously, many modifications and variations are possible. Such modifications and variations that may be apparent to an individual in the art are included within the scope of the present disclosure as defined by the accompanying claims.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

1. A memory controller for a (dynamic random-access memory) DRAM die having m DRAM banks, the memory controller comprising:
an ECC engine configured to provide error correction for the m DRAM banks, wherein the ECC engine includes:
an encoding system configured to provide error correction coding (ECC) coding redundancy to a data component and generate an ECC codeword; and
a partitioning system configured to partition the ECC codeword into m segments for storage in the m DRAM banks, wherein a first subset of the m segments each include a portion of the data component and a portion of the ECC coding redundancy, and a second subset of the m segments each include only ECC coding redundancy.

2. The memory controller of claim 1, further comprising a plurality of error detection code (EDC) encoders, wherein each EDC encoder adds d error detection bits to each of the m segments.

3. The memory controller of claim 2, further comprising read/write processing logic that implements a read request for a data segment stored in one DRAM bank according to process that includes:
reading an EDC codeword from the one DRAM bank that includes the data segment and the d error detection bits;
determining whether an error is detected in the EDC codeword; and
in response to no detected error, sending the data segment to a host processor.

4. The memory controller of claim 3, wherein in response to a detected error:
reading an entire ECC codeword from all of the m DRAM banks and performing ECC decoding to correct errors; and
sending a corrected result to the host processor.

5. The memory controller of claim 1, further comprising a mapping system that rotates placement of ECC codeword among the m DRAM banks.

6. The memory controller of claim 1, further comprising a cache configured to evict a selected cache block with a minimum eviction score to the DRAM banks.

7. The memory controller of claim 6, wherein the cache performs an ECC codeword re-encoding operation.

8. The memory controller of claim 6, wherein the cache performs a partial data update.

9. A memory controller for a dynamic random-access memory (DRAM) die having m DRAM banks, the memory controller comprising:
an error correction code (ECC) engine configured to provide error correction for the m DRAM banks, wherein the ECC engine includes:
an encoding system configured to provide ECC coding redundancy to a data component and generate an ECC codeword; and
a partitioning system configured to partition the ECC codeword into m segments for storage in the m DRAM banks, wherein a first subset of the m segments each include a portion of the data component, and a second subset of the m segments each include only ECC coding redundancy; and
a plurality of error detection code (EDC) encoders, wherein each EDC encoder adds d error detection bits to each of the m segments.

10. The memory controller of claim 9, further comprising read/write processing logic that implements a read request for a data segment stored in one DRAM bank according to process that includes:
reading an EDC codeword from the one DRAM bank that includes the data segment and the d error detection bits;
determining whether an error is detected in the EDC codeword; and
in response to no detected error, sending the data segment to a host processor.

11. The memory controller of claim 10, wherein in response to a detected error:
reading an entire ECC super-codeword from all of the m DRAM banks and performing ECC decoding to correct errors; and
sending a corrected result to the host processor.

12. The memory controller of claim 9, further comprising read/write processing logic that implements a write request to update an existing data segment stored in one DRAM bank with a new data segment according to process that includes:
reading the existing data segment in the one DRAM bank and the second subset of the m segments;
determining whether any errors are detected;
in response to no errors occurring, updating the existing data segment with the new data segment;
performing ECC and EDC encoding on the first subset of m segments to generate an updated coding redundancy; and
writing the new data segment and updated coding redundancy to the one data DRAM bank and second subset of m segments.

13. The memory controller of claim 12, wherein in response to a detected error:
reading an entire ECC super-codeword from all of the m DRAM banks;
updating the existing data segment with the new data segment; and
performing ECC and EDC encoding to create a new super-codeword; and
writing the new super-codeword to all of the m DRAM banks.

14. The memory controller of claim 9, further comprising a cache having a plurality of cache blocks, each configured for holding a data component.

15. The memory controller of claim 14, wherein each cache block includes a 1-bit valid flag.

16. The memory controller of claim 15, wherein the cache evicts a selected cache block with a minimum eviction score to the DRAM banks.

17. The memory controller of claim 16, wherein the cache performs an ECC codeword re-encoding operation.

18. The memory controller of claim 16, wherein the cache performs a partial data update.

19. The memory controller of claim 6, further comprising a mapping system that rotates placement of ECC codeword among the m DRAM banks.
